(19) United States
(12) Patent Application Publication
(10) Pub. No.: US 2024/0060803 A1
(43) Pub. Date: Feb. 22, 2024

(54) FLUID RESISTANCE ELEMENT, FLUID CONTROLLER, AND METHOD OF MANUFACTURING FLUID RESISTANCE ELEMENT

(71) Applicant: HORIBA STEC, Co., Ltd., Kyoto-shi (JP)

(72) Inventors: Masaki KOBAYASHI, Kyoto-shi (JP); Tadahiro YASUDA, Kyoto-shi (JP)

(21) Appl. No.: 18/446,668

(22) Filed: Aug. 9, 2023

(30) Foreign Application Priority Data
Aug. 19, 2022 (JP) 2022-130880

(51) Int. Cl. G01F 1/40; G05D 7/06

(52) U.S. Cl. CPC G01F 1/40; G05D 7/0635

(57) ABSTRACT

In order to allow a fluid resistance element to be fixed to the channel while enjoying various benefits of a channel delineating member made from a ceramic, the fluid resistance element includes: a channel delineating member made from a ceramic and having one or a plurality of resistance channels; and a covering member made from a metal and covering an outer peripheral surface of the channel delineating member. The covering member has a bulged portion on an inner peripheral surface of the covering member, the bulged portion bulging toward the outer peripheral surface of the channel delineating member.

### BACKGROUND OF THE INVENTION

### 1. Technical Field

The present invention relates to a fluid resistance element, a fluid controller including the fluid resistance element, and a method of manufacturing the fluid resistance element.

### 2. Description of the Related Art

As a conventional fluid resistance element, there is a fluid resistance element that is a ceramic cylinder including a plurality of resistance channels each having a very small diameter, as disclosed in WO2021/095492 A.

Compared with a conventional fluid resistance element made from a metal, such a ceramic fluid resistance element exhibits physical properties such as a near-zero thermal expansion coefficient, a high degree of hardness, and excellent heat resistance and corrosion resistance, and, therefore, enables very accurate flow rate measurements, particularly when the flow rate to be controlled is low.

However, due to a physical property of ceramic being hardly deformable, fixing a ceramic fluid resistance element to a channel has been difficult, disadvantageously. Although WO2021/095492 A describes an example in which a ceramic cylinder is fitted into a metal cylinder by means of interference fitting or clearance-fitting, for example, all of these fixing methods are technically difficult, and there are many obstacles to overcome to adopt such methods in reality.

### PRIOR ART DOCUMENT

### Patent Document

Patent Document 1: WO2021/095492 A

### SUMMARY OF THE INVENTION

The present invention has been made to address all of the obstacles described above at once, and it is a main object of the present invention to enable a fluid resistance element made from a ceramic to be fixed to a channel while enjoying the benefits of the ceramic fluid resistance element.

In other words, a fluid resistance element according to the present invention includes: a channel delineating member made from a ceramic and having one or a plurality of resistance channels; and a covering member made from a metal and covering an outer peripheral surface of the channel delineating member, and the covering member has a bulged portion on an inner peripheral surface of the covering member, the bulged portion bulging toward the outer peripheral surface of the channel delineating member.

With the fluid resistance element having such a configuration, the channel delineating member is made from a ceramic. Therefore, it is possible to enjoy the benefits that are unique to ceramic, such as having a near-zero thermal expansion coefficient, a high degree of hardness, and having an excellent heat resistance and a corrosion resistance.

In addition, by applying a radial force from the outer side and crimping the covering member made from a metal, to form the bulged portion on the inner peripheral surface of the covering member, the channel delineating member can be fixed to the covering member. By then fixing the covering member made from a metal to another tube member by welding, for example, the fluid resistance element can be fixed to a desirable position of a channel.

Preferably, the bulged portion extends in a circumferential direction, on an inner peripheral surface of the covering member.

With such a configuration, the channel delineating member can be fixed to the covering member more reliably.

Preferably, the covering member has a recessed portion on an outer peripheral surface of the covering member, the recessed portion being recessed radially inward toward the outer peripheral surface of the channel delineating member.

As described above, by forming the recessed portion to the outer peripheral surface of the covering member, the bulged portion described above can be formed correspondingly on the inner peripheral surface of the covering member, and the channel delineating member can thus be fixed to the covering member.

Preferably, the covering member has a tubular shape, and has a housing space in which the channel delineating member is housed, wherein a predetermined section having the housing space is thinner than other sections, the predetermined section and the other sections being sections of the covering member in an axial direction.

With such a configuration, because the predetermined section having the housing space is made thinner than the other sections, it is possible to recognize where the channel delineating member is housed, just by looking. Furthermore, by making the predetermined section thin, the predetermined section can be crimped easily, so that workability is improved.

Preferably, the covering member includes a downstream channel that is provided downstream of the channel delineating member, and into which the fluid passed through the resistance channel is guided, and the downstream channel includes a small-diameter portion having a channel diameter smaller than an outer diameter of the channel delineating member.

With such a configuration, the channel delineating member inserted into the covering member gets stuck on the small-diameter portion, so that the channel delineating member can be prevented from coming off on the downstream side.

Preferably, the downstream channel includes an increasing diameter portion that is provided downstream of the small-diameter portion and that has a channel diameter increasing from an upstream side toward a downstream side.

With this, the increasing diameter portion serves to make the pressure of the fluid having passed through the resistance channel uniform before the fluid is guided further downstream, so the flow rate can be measured more accurately.

Preferably, the covering member has a decreasing diameter portion that is provided on an upstream side of the channel delineating member, and in which a channel diameter decreases from an upstream side toward a downstream side.

With this, because the decreasing diameter portion serves as a guide when the channel delineating member is inserted, workability can be improved.

In order to fix the fluid resistance element to a desirable position of the channel, preferably, opposing axial end portions of the covering member are welded portions that are welded to other tube members, respectively.

A fluid controller according to the present invention includes: the fluid resistance element described above provided in a channel through which a fluid flows; an upstream pressure sensor and a downstream pressure sensor provided on an upstream side and a downstream side of the fluid resistance element, respectively, in the channel; and a flow rate regulation valve provided in the channel.

Furthermore, another fluid controller according to the present invention includes: the fluid resistance element described above provided in a channel through which a fluid flows; a sensor channel that connects an upstream side and a downstream side of the channel; an upstream electric resistance element and a downstream electric resistance element provided on the sensor channel; and a flow rate regulation valve provided to the channel.

With a differential pressure fluid controller or a thermal fluid controller having the configuration described above, because the fluid resistance element described above is provided, it is possible to achieve the same operational effects as those achieved by the fluid resistance element according to the present invention.

A more specific implementation example includes an example in which the channel includes a plurality of the fluid resistance elements that are provided in series or in parallel.

The plurality of fluid resistance elements preferably have respective resistances that are mutually different.

With this, it is possible to achieve various levels of resistance using a plurality of fluid resistance elements.

In addition, a method of manufacturing a fluid resistance element according to the present invention includes: a step of covering an outer peripheral surface of a channel delineating member made from a ceramic and having one or a plurality of resistance channels, with a covering member made from a metal; and a step of fixing the channel delineating member to the covering member by applying a radial force from an outer side and crimping the covering member.

With such a manufacturing method, it is possible to achieve the same functions and effects as those achieved by the fluid resistance element described above, and it is possible to fix the fluid resistance element to a desirable position of the channel, while enjoying the benefits of a fluid resistance element made from a ceramic.

According to the present invention having the configuration described above, it is possible to fix the fluid resistance element to a desirable position of the channel, while enjoying various benefits of a channel delineating member made from a ceramic.

### BRIEF DESCRIPTION OF THE DRAWINGS

FIG. 1 is a fluid circuit diagram of a fluid controller according to an embodiment of the present invention;

FIG. 2 is a cross-sectional view illustrating a part of an internal structure of the fluid controller according to the embodiment;

FIG. 3 is a schematic diagram illustrating a configuration of a fluid resistance element according to the embodiment;

FIGS. 4A and 4B are schematic diagrams illustrating a configuration of the fluid resistance element according to the embodiment;

FIG. 5 is a schematic diagram for explaining crimping according to the embodiment;

FIG. 6 is a schematic diagram illustrating an arrangement of fluid resistance elements in another embodiment;

FIG. 7 is schematic diagrams illustrating an arrangement of fluid resistance elements in another embodiment;

FIG. 8 is a schematic diagram illustrating a configuration of a holder block according to another embodiment; and

FIG. 9 is a fluid circuit diagram of a fluid controller according to another embodiment.

### DETAILED DESCRIPTION

One embodiment of a fluid resistance element according to the present invention will now be explained with reference to some drawings.

The fluid resistance element according to this embodiment is a component of a fluid controller that controls the mass flow rate of material gas or the like used for semiconductor manufacturing, for example.

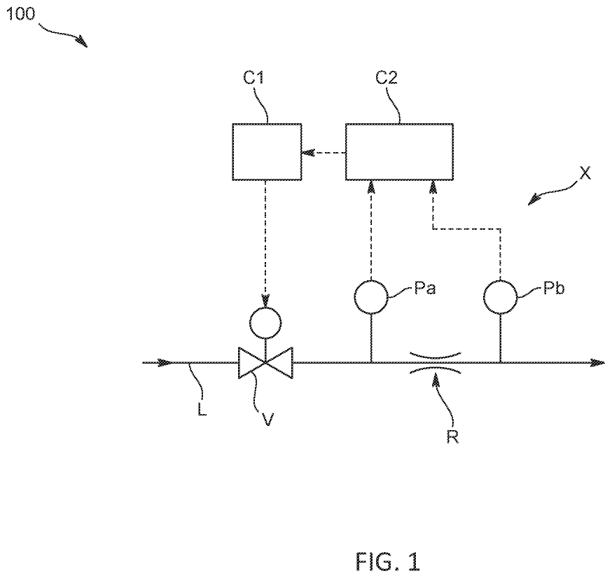

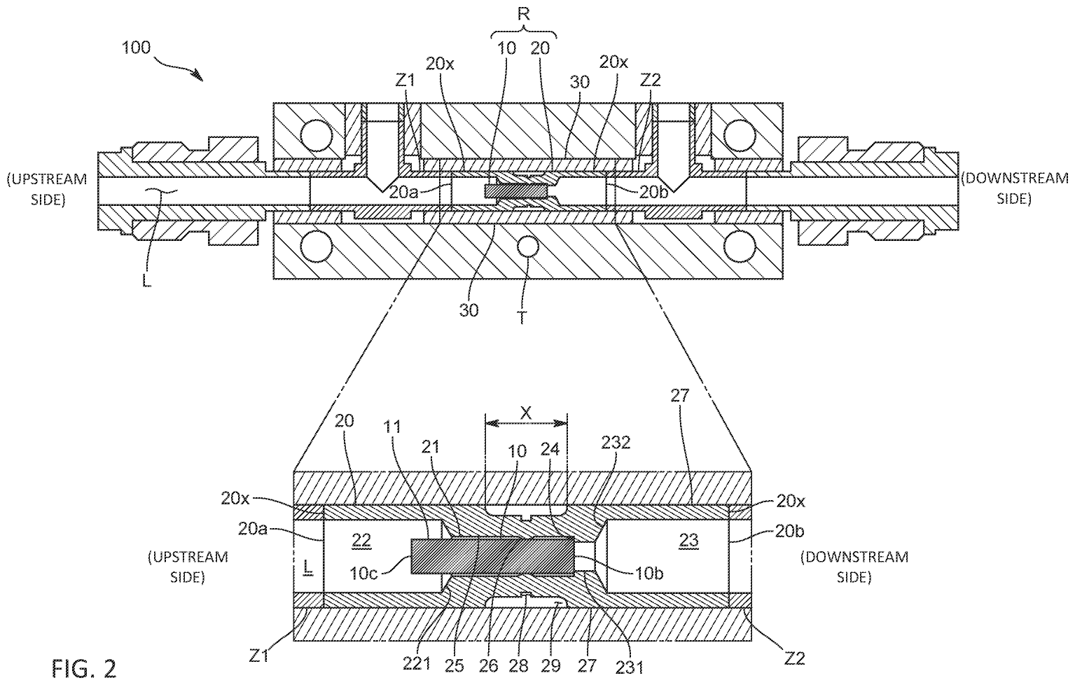

Specifically, this fluid controller 100 includes, as a fluid circuit diagram thereof is illustrated in FIG. 1 and a part of the internal structure thereof is illustrated in FIG. 2, an internal channel L through which a fluid to be controlled flows, a flow rate regulation valve V that is provided to the internal channel L, a flow rate measurement mechanism X that is provided downstream of the flow rate regulation valve V and that measures a flow rate of the fluid flowing through the internal channel L, and a control circuit C1 that controls the flow rate regulation valve V in such a manner that the flow rate measured by the flow rate measurement mechanism X is brought to a predetermined target.

As illustrated in FIG. 1, the flow rate measurement mechanism X is a differential pressure flow meter, and includes an upstream pressure sensor Pa provided on an upstream side of the internal channel L, a downstream pressure sensor Pb provided on the downstream of the upstream pressure sensor Pa, a fluid resistance element R provided in the internal channel L between the upstream pressure sensor Pa and the downstream pressure sensor Pb and creates a pressure difference, and a flow rate calculation circuit C2 that calculates the flow rate of the fluid flowing through the internal channel L based on the pressure measurements of the up stream pressure sensor Pa and the downstream pressure sensor Pb, and the resistance of the fluid resistance element R.

Because the fluid resistance element R is a characterizing part of this embodiment, the fluid resistance element R will now be described in detail.

As illustrated in FIGS. 2 to 4A and 4B, the fluid resistance element R serves as resistance when the fluid flows, and specifically, includes a ceramic channel delineating member 10 having channels 10a (hereinafter, also referred to as resistance channels 10a) that serves as a resistance, and a metallic covering member 20 covering the outer peripheral surface 11 of the channel delineating member 10.

The channel delineating member 10 is made from a ceramic such as quartz, alumina, zirconia, or silicon nitride, and, specifically, has a cylindrical shape, and has about one to several hundred resistance channels 10a extending along the axial direction. The channel delineating member 10 has a diameter (outer diameter) of about several millimeters (e.g., 1.5 mm) and a length (dimension in the axial direction) of about several millimeters to several tens millimeters (e.g., 7 mm), but these sizes may be changed as appropriate.

Each of the resistance channels 10a penetrates the channel delineating member 10 in the axial direction and has a linear shape with a circular cross section. These resistance channels 10a include, for example, a resistance channel provided along the tube axis of the channel delineating member 10, and a plurality of resistance channels that are regularly arranged around the tube axis. The resistance channel 10a has a diameter (inner diameter) of less than 1 millimeter and about several tens of micrometers (e.g., 30 μm), and a length (dimension in the axial direction) of about several millimeters to several tens of millimeters (e.g., 7 mm), which is the same as that of the channel delineating member 10, but these sizes may be changed as appropriate.

In this embodiment, the aspect ratio, which is the ratio of the length with respect to the diameter of the resistance channel 10a, is 200 or higher, and more preferably 300 or higher. The aspect ratio and the number of the resistance channels 10a determine the resistance of the fluid resistance element R.

The covering member 20 is made from a metal such as stainless steel or a nickel-based alloy that has a hardness lower than that of at least ceramic.

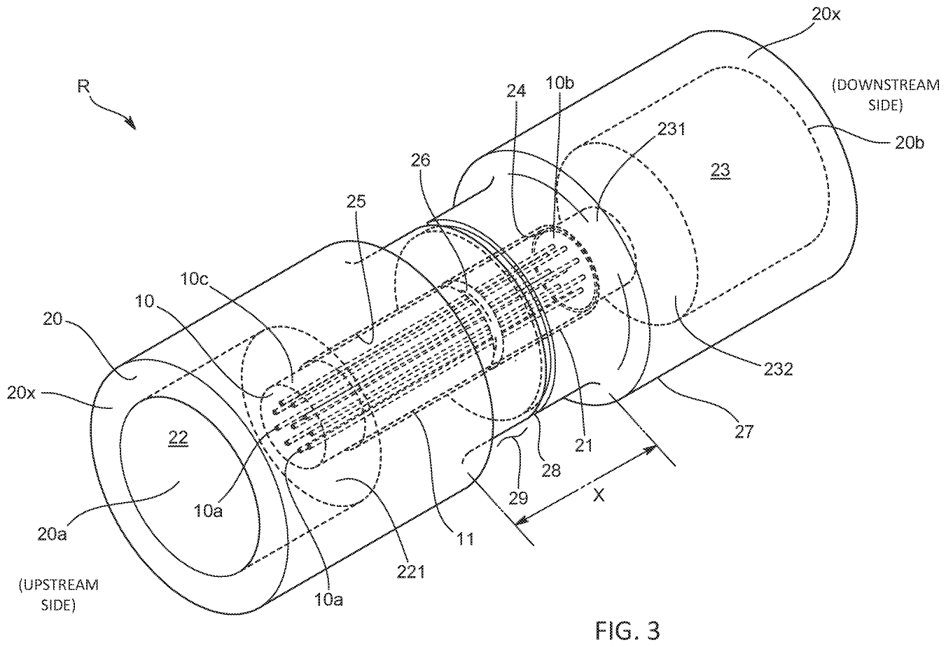

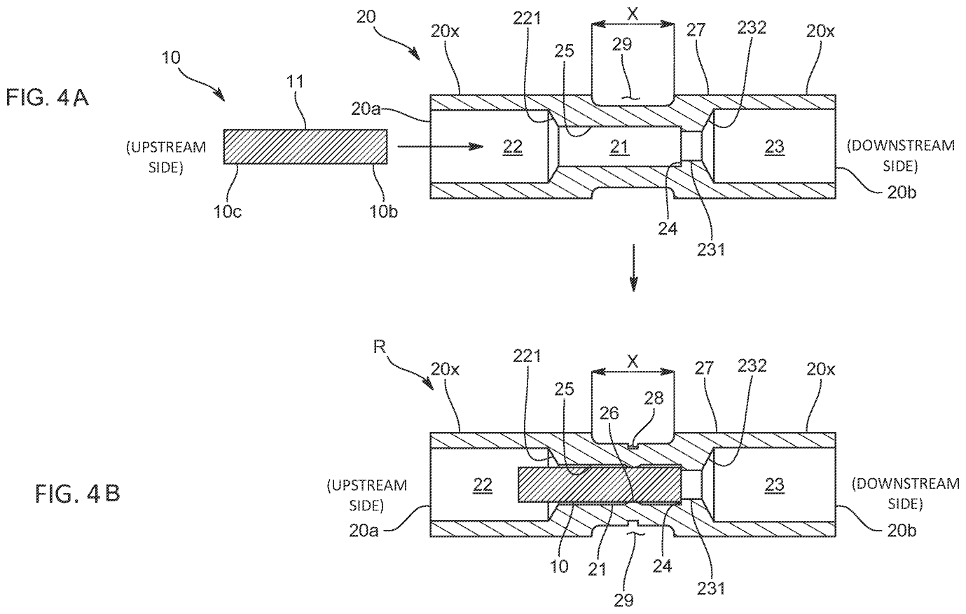

As illustrated in FIGS. 3 and 4A and 4B, the covering member 20 has a tubular shape, and covers the entire outer peripheral surface 11 of the channel delineating member 10, that is, houses the channel delineating member 10.

More specifically, as illustrated in FIGS. 4A and 4B, the covering member 20 includes a housing space 21 for housing the channel delineating member 10, an upstream channel 22 provided upstream of the housing space 21, and a downstream channel 23 provided downstream of the housing space 21.

The housing space 21 is a space for housing at least a part of the channel delineating member 10, and has an inner diameter slightly larger than the outer diameter of the channel delineating member 10.

In the housing space 21 according to this embodiment, a section including a central portion of the channel delineating member 10 and the downstream end 10b is housed inside the housing space 21, and an upstream end 10c of the channel delineating member 10 protrudes outside of the housing space 21 on the upstream side.

However, a section including the central portion of the channel delineating member 10 and the upstream end 10c may be housed inside the housing space 21, and the downstream end 10b of the channel delineating member 10 may protrude out of the housing space 21 on the downstream side, or only the central portion of the channel delineating member 10 may be housed inside the housing space 21, and the upstream end 10c and the downstream end 10b of the channel delineating member 10 may protrude out of the housing space 21. The housing space 21 may also be a space in which the entire channel delineating member 10 is housed.

The upstream channel 22 communicatively connects an upstream opening 20a of the covering member 20 and the housing space 21, and the channel delineating member 10 is inserted into the housing space 21 through the upstream channel 22.

The upstream channel 22 has a channel diameter larger than the inner diameter of the housing space 21, and, in the example explained herein, has a channel length greater than the length of the housing space 21 in the axial direction.

The upstream channel 22 according to this embodiment has a decreasing diameter portion 221 the channel diameter of which decreases from the upstream side toward the downstream side, and a downstream end of the decreasing diameter portion 221 opens to the housing space 21. In other words, the inner peripheral surface 25 of the covering member 20 has a tapered shape gradually decreasing in diameter from the upstream side toward the housing space 21, in the portion corresponding to the decreasing diameter portion 221.

The downstream channel 23 communicatively connects a downstream opening 20b of the covering member 20 and the housing space 21, and the fluid having passed through the resistance channels 10a of the channel delineating member 10 is guided to the downstream channel 23.

The downstream channel 23 has a small-diameter portion 231 the upstream end of which opens to the housing space 21, and the small-diameter portion 231 has a channel diameter smaller than the outer diameter of the channel delineating member 10.

With such a configuration, a radially outer rim of the upstream opening of the small-diameter portion 231 provides an abutting surface 24 against which the downstream end surface of the channel delineating member 10 inside the housing space 21 is brought into abutment.

With the channel delineating member 10 getting stuck on the abutting surface 24, it is possible to prevent the channel delineating member 10 from coming out of the housing space 21 into the downstream channel 23.

The downstream channel 23 according to this embodiment also includes an increasing diameter portion 232 provided downstream of the small-diameter portion 231 and having a channel diameter increasing from the upstream side toward the downstream side. In other words, the inner peripheral surface 25 of the covering member 20 has a tapered shape gradually increasing in diameter from the small-diameter portion 231 toward the downstream side, in the portion corresponding to the increasing diameter portion 232.

In this embodiment, the upstream channel 22 and the downstream channel 23 have an equal length, and the covering member 20 according to this embodiment has a symmetrical external shape, with the axial center as the axis of symmetry. However, the channel length of the upstream channel 22 and the channel length of the downstream channel 23 are not limited thereto, and may be changed as appropriate, and the external shape of the covering member 20 may also be changed to an asymmetric shape as appropriate.

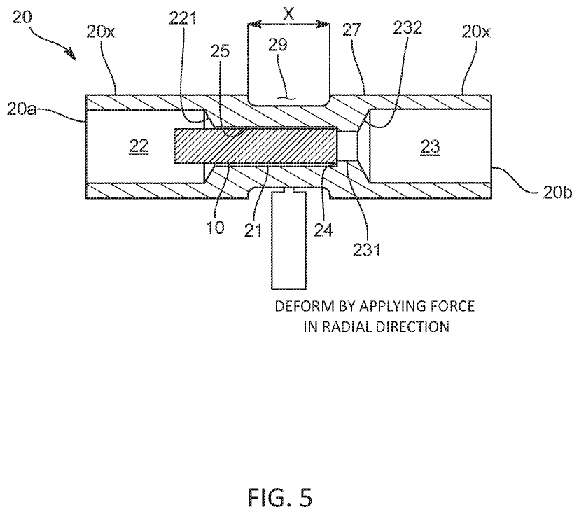

Thus, by crimping the covering member 20, a bulged portion 26 bulging toward the outer peripheral surface 11 of the channel delineating member 10 is formed on the inner peripheral surface 25 of the covering member 20, and a recessed portion 28 recessed radially inward toward the outer peripheral surface 11 of the channel delineating member 10 is formed on the outer peripheral surface 27 of the covering member 20. As illustrated in FIG. 5, crimping means deforming the covering member 20 by applying a radial force thereto.

More specifically, as illustrated in FIGS. 3 and 4A and 4B, in the covering member 20 according to this embodiment, a predetermined section X extending in the axial direction and provided with the housing space 21 described above is thinner than the other sections in the axial direction. This configuration makes it possible to recognize where the housing space 21 is provided in the axial direction, that is, where the channel delineating member 10 is housed.

In this embodiment, the entire circumference of the predetermined section X is thin, in other words, the predetermined section X is a sunken portion 29 radially sunken inward, with respect to the other sections, across the entire circumference in the circumferential direction.

In such a configuration, in this embodiment, the entire circumference of the covering member 20 is crimped in the circumferential direction, so that the bulged portion 26 is formed across the entire circumference of the inner peripheral surface 25 of the covering member 20 in the circumferential direction, and the recessed portion 28 is formed across the entire circumference of the outer peripheral surface 27 of the covering member 20 in the circumferential direction.

More specifically, the entire periphery of the thin predetermined section X described above is crimped, so that the bulged portion 26 is formed on the inner peripheral surface where the housing space 21 is provided, and the recessed portion 28 is formed in the predetermined section X described above.

The bulged portion 26 is in close contact with the outer peripheral surface 11 of the channel delineating member 10, and tightens to hold the channel delineating member 10 from the radially outer side.

In other words, the fluid resistance element R according to this embodiment is manufactured by covering the outer peripheral surface 11 of the ceramic channel delineating member 10 having the resistance channel 10a, with the metallic covering member 20, and fixing the channel delineating member 10 to the covering member 20 by applying a radial force from the outer side to crimp the covering member 20.

In such a configuration, as illustrated in FIG. 2, in the covering member 20 according to this embodiment, other tube members Z1 and Z2 are connected to and fixed to opposing axial end portions 20x, respectively, and the internal channel L is formed together with the tube members Z1 and Z2.

More specifically, the opposing axial end portions 20x of the covering member 20 are welded portions welded to other tube members Z1 and Z2, respectively, and by welding the other tube members Z1 and Z2 to the respective welded portions, the upstream opening 20a of the covering member 20 is communicatively connected to the downstream opening of the other tube member Z1, and the downstream opening 20b of the covering member 20 is communicatively connected to the upstream opening of another one of the other tube members Z2, so that the internal channel L is formed thereby.

As illustrated in FIG. 2, the covering member 20 according to this embodiment is covered by a heat transfer member 30 such as that made from aluminum that is highly thermally conductive, so that the temperature of the fluid flowing through the resistance channel 10a transfers easily to the surrounding. Near the covering member 20, a temperature sensor T that detects the temperature of the fluid flowing through the resistance channel 10a is provided.

With the fluid resistance element R according to this embodiment having the configuration described above, because the channel delineating member 10 is made from a ceramic, the channel delineating member 10 can be processed at a high dimensional accuracy, and the fluid resistance element R having uniform resistance characteristics can be manufactured stably. Specifically, for example, by using each piece resultant of cutting a long (e.g., 1m) ceramic internal of which is provided with the resistance channels 10a into the same length (e.g., about several mm) as a channel delineating member 10, any number of fluid resistance elements R having uniform resistance characteristics can be manufactured. By contrast, by changing the cut length, the fluid resistance elements R having different resistance characteristics can be manufactured easily, and it contributes to designing of various models, for example. Moreover, because the channel delineating member 10 is made from a ceramic, the channel delineating member can be inserted into the internal channel L without causing any deformation of the resistance channels 10a. Furthermore, the channel delineating member made from a ceramic also has benefits such as having a low thermal expansion coefficient, being highly corrosion resistant, and low-priced, as compared with a channel delineating member made from a metal. Furthermore, because the resistance characteristic can be changed by changing the number of the resistance channels 10a, the fluid resistance element can also be used for ultra-low flow rate measurement, for example. In addition, because each of the resistance channels 10a can be processed into a circular tubular shape, an ideal fluid flow is achieved, so that various simulations can be simplified.

As described above, the bulged portion 26 on the inner peripheral surface 25 of the covering member 20 is formed by applying a radial force from the outer side to the metallic covering member 20 and crimping the covering member 20. Therefore, by welding to fix other tube members Z1 and Z2 to the metallic covering member 20, for example, the channel delineating member 10 can be fixed to the covering member and the fluid resistance element R can be fixed to a desirable position of the channel, while enjoying the various benefits of using a ceramic to form the resistance channels 10a.

In addition, because the bulged portion 26 is provided across the entire circumference of the inner peripheral surface 25 of the covering member 20 in the circumferential direction, the channel delineating member 10 can be fixed reliably to the covering member 20.

Furthermore, because the predetermined section X extending along the axial direction and delineating the housing space 21 of the covering member 20 is thinner than the other sections of the axial direction, it is possible to recognize in which section the channel delineating member 10 is housed, just by looking. By making the predetermined section X thin, the predetermined section X can be crimped easily, so that workability is improved.

Furthermore, because the downstream channel 23 has the small-diameter portion 231 having a channel diameter smaller than the outer diameter of the channel delineating member 10, the small-diameter portion 231 supports the channel delineating member 10 inserted in the covering member 20, so that the channel delineating member 10 is prevented from coming off on the downstream side.

In addition, because the downstream channel 23 has the increasing diameter portion 232, the increasing diameter portion 232 makes the pressure of the fluid having passed through the resistance channel 10a uniform before the fluid is guided further downstream, so that the flow rate can be measured more accurately.

In addition, because the upstream channel 22 has the decreasing diameter portion 221, the decreasing diameter portion 221 functions as a guide when the channel delineating member 10 is inserted, so that workability can be improved.

In addition, because the channel delineating member 10 is covered by the covering member 20, the risk of contamination, damage, or the like of the channel delineating member 10 can be reduced, at the time of handling such as while the fluid resistance element R is being manufactured or transported.

Note that the present invention is not limited to the embodiment described above.

For example, in the embodiment described above, the bulged portion 26 is provided on the entire circumference of the inner peripheral surface 25 of the covering member 20, but may also be provided on a part of the inner peripheral surface 25 in the circumferential direction. Specifically, the bulged portion 26 is preferably provided on a half or more the circumference of the inner peripheral surface 25 in the circumferential direction, and more preferably provided on three fourth or more the circumference of the inner peripheral surface 25 in the circumferential direction.

In the embodiment described above, the recessed portion 28 is provided in the outer peripheral surface 27 of the covering member 20, but it is also possible for the recessed portion 28 not to be provided in the outer peripheral surface 27 of the covering member 20, e.g., by making the portion to be crimped thick in advance.

In the embodiment described above, the predetermined section X along the axial direction including the housing space 21 of the covering member 20 is made thin, but it is not always necessary to provide this thin portion, and the covering member 20 may have a constant outer diameter across the opening on one end to the opening on the other end, for example.

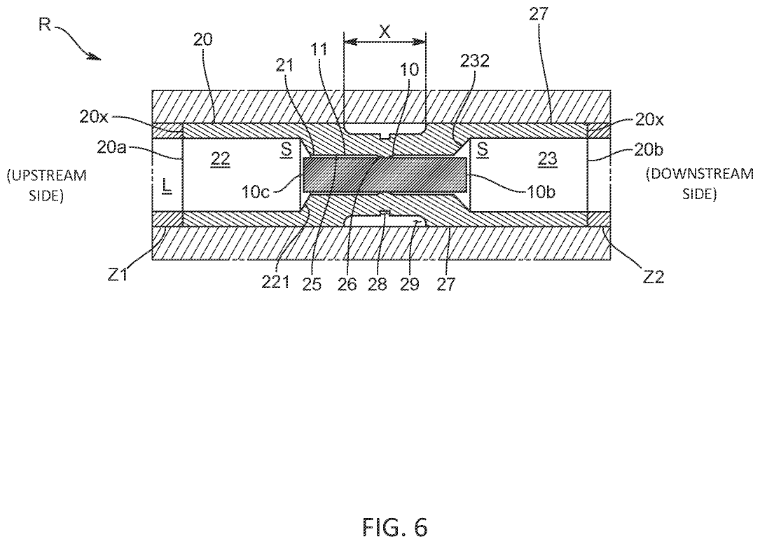

Furthermore, as illustrated in FIG. 6, as the covering member 20, it is also possible to ensure spaces S into which the end portions of the channel delineating member 10 can be inserted, on the upstream and the downstream sides of the housing space 21, respectively. These spaces S form parts of the upstream channel 22 and the downstream channel 23, respectively.

With such a configuration, when the channel delineating member 10 is inserted into the housing space 21, the channel delineating member 10 is allowed to displace to the upstream side or the downstream side.

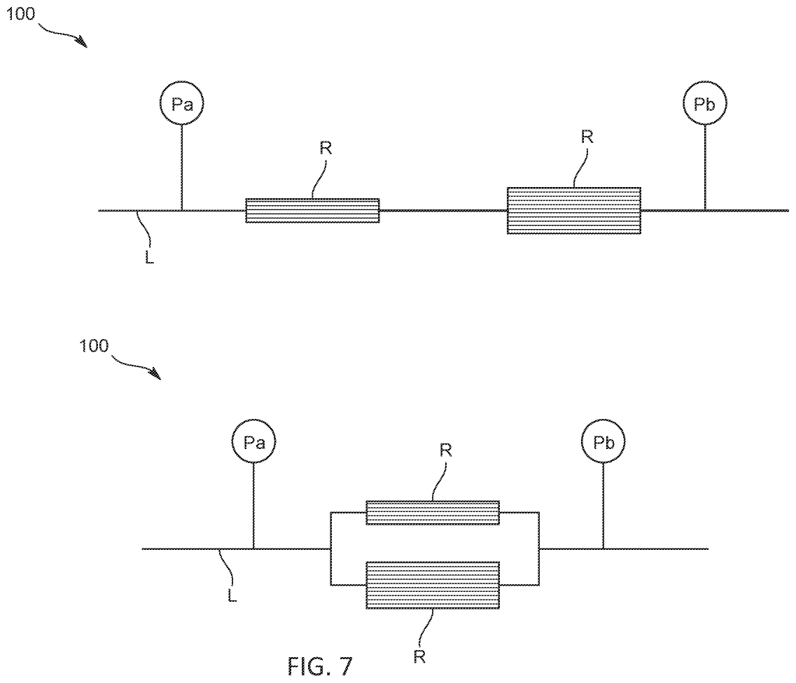

In the embodiment described above, the fluid controller 100 includes the single fluid resistance element R, but may also include a plurality of fluid resistance elements R, as illustrated in FIGS. 7A and 7B.

Examples thereof include an example in which a plurality of fluid resistance elements R are provided in series as illustrated in FIG. 7A, and an example in which a plurality of fluid resistance elements R are provided in parallel as illustrated in FIG. 7B.

In such configurations, the plurality of fluid resistance elements R may have resistances different from each other, or may have resistances equal to each other.

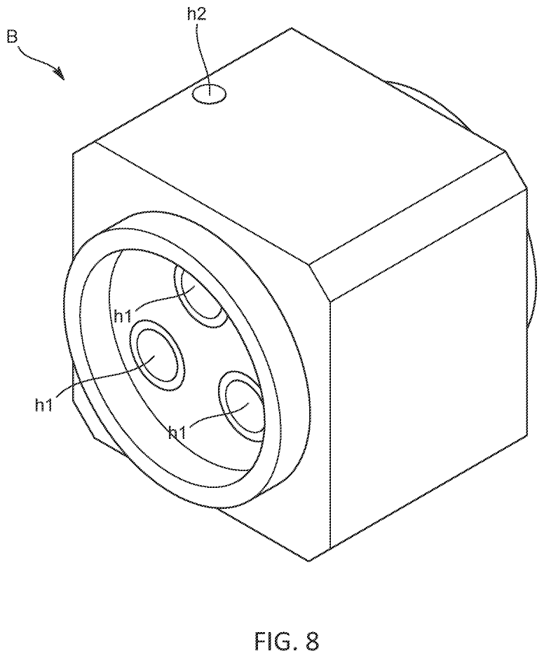

When a plurality of fluid resistance elements R are used in the manner described above, the fluid controller 100 may include a holder block B for holding the plurality of fluid resistance elements integrally, as illustrated in FIG. 8.

The holder block B has a plurality of element insertion holes h1 into which the respective fluid resistance elements R are inserted, and after the fluid resistance elements R are inserted into these element insertion holes h1, respectively, another tubular member (not illustrated) is connected to each covering member 20 by welding, for example, so that the fluid resistance element R is fixed to a desirable position of the channel. The holder block B herein is also provided with a temperature sensor attachment hole h2 to which a temperature sensor (not illustrated) is attached.

Furthermore, although the channel delineating member 10 has a cylindrical shape in the embodiment described above, when the channel has a triangular, quadrangular, or polygonal cross section, the channel delineating member 10 may also have a columnar shape having a triangular, quadrangular, or polygonal cross section, in accordance with such a shape. In this case, the covering member 20 may also have a tubular shape having a triangular, quadrangular, or polygonal cross section corresponding to the cross-sectional shape of the channel.

The fluid controller 100 may be another device or unit such as a flow meter (flow rate measuring device) not including the flow rate regulation valve V.

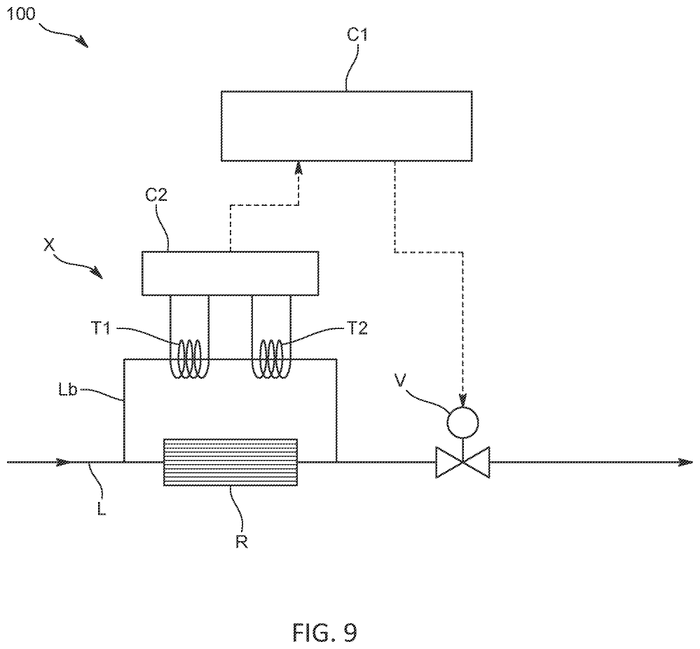

In the embodiment described above, the fluid resistance element R is included in a pressure fluid controller 100. However, as illustrated in FIG. 9, a thermal fluid controller 100 including a thermal flow rate sensor in the internal channel L may also be used. Specifically, the flow rate measurement mechanism X in such a case includes a fluid resistance element R provided in the internal channel L, a sensor channel Lb connecting the upstream side and the downstream side of the internal channel L, an upstream electric resistance element T1 and a downstream electric resistance element T2 provided in the sensor channel Lb, and a flow rate calculation circuit C2 that calculates the flow rate of the fluid based on the output values from the electric resistance elements T1 and T2.

In addition, the present invention is not limited to the embodiment described above, and it should be needless to say that various modifications may be made within the scope not departing from the gist of the present invention.

### LIST OF REFERENCE CHARACTERS

100 fluid controller
L internal channel
Pa upstream pressure sensor
Pb downstream pressure sensor
R fluid resistance element
10 channel delineating member
11 outer peripheral surface
10a resistance channel
20 covering member
21 housing space
22 upstream channel
221 decreasing diameter portion
23 downstream channel
231 small-diameter portion
232 increasing diameter portion
20a upstream opening
20b downstream opening
24 abutting surface
25 inner peripheral surface
26 bulged portion
27 outer peripheral surface
28 recessed portion
29 sunken portion
20x opposing axial end portion
X predetermined section

What is claimed is:

1. A fluid resistance element comprising:
a channel delineating member made from a ceramic and having one or a plurality of resistance channels; and
a covering member made from a metal and covering an outer peripheral surface of the channel delineating member,
wherein the covering member has a bulged portion on an inner peripheral surface of the covering member, the bulged portion bulging toward the outer peripheral surface of the channel delineating member.

2. The fluid resistance element according to claim 1, wherein the bulged portion extends in a circumferential direction, on an inner peripheral surface of the covering member.

3. The fluid resistance element according to claim 1, wherein the covering member has a recessed portion on an outer peripheral surface of the covering member, the recessed portion being recessed radially inward toward the outer peripheral surface of the channel delineating member.

4. The fluid resistance element according to claim 1, wherein the covering member has a tubular shape, and has a housing space in which the channel delineating member is housed, wherein a predetermined section having the housing space is thinner than other sections, the predetermined section and the other sections being sections of the covering member in an axial direction.

5. The fluid resistance element according to claim 1, wherein
the covering member includes a downstream channel that is provided downstream of the channel delineating member, and into which the fluid passed through the resistance channel is guided, and
the downstream channel includes a small-diameter portion having a channel diameter smaller than an outer diameter of the channel delineating member.

6. The fluid resistance element according to claim 5, wherein the downstream channel includes an increasing diameter portion that is provided downstream of the small-diameter portion and that has a channel diameter increasing from an upstream side toward a downstream side.

7. The fluid resistance element according to claim 1, wherein the covering member has a decreasing diameter portion that is provided on an upstream side of the channel delineating member, and in which a channel diameter decreases from an upstream side toward a downstream side.

8. The fluid resistance element according to claim 1, wherein opposing axial end portions of the covering member provide welded portions that are welded to other tube members, respectively.

9. A fluid controller comprising:
the fluid resistance element according to claim 1 that is provided in a channel through which a fluid flows;
an upstream pressure sensor and a downstream pressure sensor provided on an upstream side and a downstream side of the fluid resistance element, respectively, in the channel; and
a flow rate regulation valve provided in the channel.

10. A fluid controller comprising:
the fluid resistance element according to claim 1 that is provided in a channel through which a fluid flows;
a sensor channel that connects an upstream side and a downstream side of the channel;
an upstream electric resistance element and a downstream electric resistance element provided on the sensor channel; and
a flow rate regulation valve provided to the channel.

11. The fluid controller according to claim 9, wherein the channel includes a plurality of the fluid resistance elements that are provided in series or in parallel.

12. The fluid controller according to claim 11, wherein the plurality of fluid resistance elements have respective resistances that are mutually different.

13. A method of manufacturing a fluid resistance element, the method comprising:
a step of covering an outer peripheral surface of a channel delineating member made from a ceramic and having one or a plurality of resistance channels, with a metallic covering member; and
a step of fixing the channel delineating member to the covering member by applying a radial force from an outer side and crimping the covering member.
